(19) United States
(12) Patent Application Publication
(10) Pub. No.: US 2007/0021020 A1
(43) Pub. Date: Jan. 25, 2007

(54) Outdoor fabric having improved properties and process for manufacturing the same

(75) Inventors: Mario Pinton, Marghera (IT); Raffaele Tedesco, Mestre (IT); Matteo Parravicini, Monza (IT)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: PARA' S.p.A., Pontirolo Nuovo (IT)

(21) Appl. No.: 11/313,857

(22) Filed: Dec. 22, 2005

(30) Foreign Application Priority Data
Jul. 20, 2005 (IT) MI2005A 001385

(51) Int. Cl. B32B 5/02; B32B 27/00; B32B 27/02; B05D 1/12; B05D 3/02; B05D 1/02; B05D 7/00

(52) U.S. Cl. 442/59; 442/130; 442/164; 427/372.2; 427/180; 427/421.1; 427/429

(57) ABSTRACT

Outdoor fabric based on spun acrylic fibres in which the said fabric is associated with at least one polymer selected from a group comprising melamine resins, fluoropolymers and mixtures thereof, and anatase titanium dioxide nanoparticles. A process for improving the resistance of an outdoor fabric to atmospheric agents and pollutants comprising the steps of associating an outdoor fabric based on spun acrylic fibres with at least one polymer selected from the group comprising melamine resins, fluoropolymers and mixtures thereof, and with anatase titanium dioxide nanoparticles.

This invention relates to an outdoor fabric having improved properties and a process for manufacturing the same.

In particular this invention relates to an outdoor fabric having improved properties of resistance to atmospheric agents and pollutants.

Even more particularly, this invention relates to an outdoor fabric associated with at least one polymer and particles of anatase titanium dioxide.

Outdoor fabrics are widely available and are mainly used to produce awnings for protection against the sun's rays.

Outdoor fabrics are also used to produce private areas (gazebos, etc.), to produce a decorative effect, to delimit commercial areas, to cover garden furniture, to cover boats and vehicles, and the like.

The said fabrics are generally obtained by weaving natural fibres such as, for example, cotton, or artificial fibres such as artificial cellulose fibres or synthetic polymer fibres.

The most valuable outdoor fabrics comprise yarn of synthetic polymer fibres produced by known methods comprising the following steps:
extruding a synthetic polymer in the molten state or, in the case of a polymer which does not have a melting point, a solution of the polymer,
producing flocks from the yarn so obtained,
optional dyeing of the flocks
spinning of the flocks into a yarn having the desired properties, and
weaving the said yarn.

However few polymer fibres are capable of withstanding the weather and the sun's radiation for at least 5 years without undergoing significant structural deterioration due to depolymerisation of the polymer matrix of the fibre. Also, when they are coloured, these fibres also undergo significant deterioration of the colour due to degradation of the dye.

Acrylic fibres have a prominent place among the polymer fibres most resistant to the abovementioned type of depolymerisation, while the dyes which are most resistant to the weather and solar radiation are some highly fast dyes (organic pigments) well known to those skilled in the art.

Thus outdoor fabrics produced using acrylic fibres mass-dyed with specific highly fast dyes (organic pigments) have conquered the high range of the market and are capable of providing manufactured articles in an unlimited range of colours.

These outdoor fabrics may be made waterproof by treatment with suitable polymers capable of forming a hydrophobic protection which is sufficiently flexible not to crack when the fabric is rolled up and unrolled. In addition to waterproofing the fabric, this treatment' may also improve its mechanical resistance to wear. According to the applicant's experience, typical examples of suitable waterproofing polymers are melamine resins, fluoropolymers and mixtures thereof.

A major problem facing the manufacturers of outdoor fabrics every day is that of preserving aesthetic appearance over time from damage caused by atmospheric agents such as nitrogen oxides (NOₓ), sulphur oxides (SOₓ), volatile organic substances (VOC), unburnt oils, bird droppings, plant spores carried by the wind, and the like.

Manufacturers of outdoor fabrics suggest different forms of maintenance and ways of washing to preserve manufactured articles unchanged over time. However, either through carelessness by the final user or through use in very polluted environments, such as areas having a high level of urban traffic or industrial areas, outdoor fabrics lose their initial brightness in a short time and become dirty, opaque and contaminated with moulds and/or fungi.

U.S. Pat. No. 6,037,280 describes a fabric which incorporates particles which are capable of blocking UV rays. Among very many types of particles the aforesaid document also mentions particles of TiO₂, but their crystallisation phase is not indicated. Some examples illustrated in the aforesaid document illustrate results obtained with mica particles coated with TiO₂. A single example relates to the use of pure TiO₂ particles and the results illustrated in Table 7 indicate that the TiO₂ used there, the crystallisation phase of which is not known, has a low capacity for blocking UV rays.

There is therefore a very great need to preserve the aesthetic appearance of outdoor fabrics from damage caused by atmospheric agents and pollutants over time.

Now surprisingly it has been found that this problem can be solved by associating an outdoor fabric with at least one suitable polymer and nanoparticles of anatase titanium dioxide.

In a first aspect this invention relates to an outdoor fabric based on spun acrylic fibres in which the said fabric is characterised in that it is associated with:
at least one polymer selected from the group comprising melamine resins, fluoropolymers and mixtures thereof, and
nanoparticles of anatase titanium dioxide.

In a second aspect this invention relates to a process for improving the resistance of an outdoor fabric to atmospheric agents and pollutants, characterised in that the said process comprises the steps of associating an outdoor fabric based on spun acrylic fibres with at least one polymer selected from the group comprising melamine resins, fluoropolymers and mixtures thereof, and with nanoparticles of anatase titanium dioxide.

In this description and the attached claims the following terms will have the following meanings:
a) “acrylic fibre” means a fibre based on polyacrylonitrile. Typically the said “acrylic fibre” is a copolymer of acrylonitrile and vinyl acetate or acrylonitrile and methyl acrylate. Generally the said polymer comprises 80 to 96% by weight of acrylonitrile units and 20 to 4% by weight of vinyl acetate or methyl acrylate units. Preferably the said copolymer comprises 90 to 96% by weight of acrylonitrile units and 10 to 4% by weight of vinyl acetate or methyl acrylate units. More preferably the said copolymer comprises 93 to 96% by weight of acrylonitrile units and 7 to 4% by weight of vinyl acetate or methyl acrylate units.
b) “melamine resin” means a thermosetting cross-linked polymer obtained by reacting melamine (1,3,5-triazine-2,4,6-triamine) with formaldehyde. Preferably the said melamine resin will be of the alkyl-modified type.
c) “fluoropolymer” means a fluorinated polymer. Typically the said fluorinated polymer is a fluoropolyolefin obtained by the polymerisation of an aliphatic hydrocarbon having at least one ethylene double bond and 2 to 12 carbon atoms and in which at least one hydrogen atom on each carbon atom has been substituted by a fluorine atom. Preferably the said monomer has 2 to 4 carbon atoms. A typical example of fluoropolyolefin according to this invention is polyfluorotetraethylene, also known as Teflon™ and PTFE,
d)“anatase” indicates a tetragonal phase, also known by the name of octahedrite, which is different from the other tetragonal phase of titanium dioxide known by the name of rutile (which is by far the commonest) and the rhombic phase known by the name of brookite.

Anatase titanium dioxide crystals have a typical bipyramidal structure resembling to the shape of an octahedron,
e) “nanonanoparticle” indicates a particle having an average size ≦200 nm, preferably ≦50 nm, even more preferably ≦10 nm.

Typically the said at least one polymer and the said anatase titanium dioxide nanoparticles are associated with at least one of the two surfaces of the said fabric. Advantageously the said at least one polymer and the said anatase titanium dioxide nanoparticles are associated with both surfaces of the said fabric.

Preferably the said at least one polymer is selected from polymers and mixtures of polymers which are capable of making the fabric waterproof.

Preferably the anatase titanium dioxide nanoparticles used according to this invention are transparent so that they do not affect the colour of the fabric.

Advantageously the anatase titanium dioxide nanoparticles may be associated with the said fabric, as will be described below, in the form of a powder dispersed in water, an aqueous colloidal dispersion, an aqueous dispersion stabilised with acids, and the like.

Typically the quantity of anatase titanium dioxide nanoparticles associated with the said fabric will be of from 0.1 to 10 parts by weight for 100 parts by weight of fabric. Preferably the said quantity will be of from 0.3 to 6 parts by weight for 100 parts by weight of fabric. Even more preferably the said quantity will be of from 0.5 to 5 parts by weight for 100 parts by weight of fabric.

The association between the said at least one polymer and the said fabric is preferably carried out by application to the fabric of at least one preselected monomer and/or prepolymer and subsequent heat treatment, possibly in the presence of a suitable catalyst, according to techniques which are known to those skilled in the art such as, for example, the conditions recommended by the manufacturers of the said preselected monomer and/or prepolymer.

When the fabric is associated with a mixture of polymers, a liquid mixture comprising at least one preselected monomer or prepolymer and at least one polymer having a preselected degree of polymerisation is preferably applied to the fabric so that the subsequent heat treatment promotes polymerisation of the said monomer or prepolymer to provide a flexible solid matrix which incorporates the said at least one polymer having a preselected degree of polymerisation.

Preferably the said mixture also comprises a catalyst capable of promoting polymerisation of the said preselected monomer or prepolymer and/or also comprises additives known to those skilled in the art such as, for example, emulsifiers and dispersants.

Advantageously the said association of the said at least one polymer with the said fabric is carried out by applying a mixture of a prepolymer which is a reaction product of melamine/formaldehyde possibly alkyl-modified, and at least one fluoropolymer having a preselected degree of polymerisation to the said fabric and subsequent heat treatment which causes cross-linking of the said prepolymer to yield a flexible solid matrix of melamine resin which incorporates the said at least one fluoropolymer.

In a preferred embodiment this invention therefore relates to an outdoor fabric based on spun acrylic fibres in which the said fabric is associated with:
at least one flexible solid matrix of melamine resin incorporating at least one fluoropolymer, and
nanoparticles of anatase titanium dioxide.

The temperature and time for the said heat treatment depend on parameters known to those skilled in the art, such as, for example, the nature of preselected monomer(s) and/or prepolymer(s), the possible. presence of catalyst(s), and the desired final degree of polymerisation.

Preferably the said heat treatment is carried out at a temperature of at least 150° C. for at least 1 second. More preferably the said treatment is carried out at a temperature of from 150° C. to 200° C. for a time of from 1 second to 10 minutes. Even more preferably the said treatment is carried out at a temperature of from 150° C. to 180° C. for a time of from 1 second and 3 minutes.

Advantageously the said treatment is carried out in the presence of a catalyst.

In turn application of the said monomer(s) and/or prepolymer(s) to the fabric will also be carried out using techniques well known to those skilled in the art such as, for example, rolling, brushing, spraying, spreading and similar techniques. The technique used will depend on the nature of the selected monomer(s) and/or prepolymer(s) and the quantity applied.

The association between the said anatase titanium dioxide nanoparticles and the said fabric will preferably be carried out by applying the said nanoparticles during or after application of the said monomer(s) and/or prepolymer(s).

In one embodiment the anatase titanium dioxide nanoparticles are applied after application of the said monomer(s) and/or prepolymer(s) but before the said heat treatment. In this case the said nanoparticles remain incorporated in and on the upper surface of the said at least one polymer formed during the said heat treatment.

The anatase titanium dioxide nanoparticles may however also be applied after the said heat treatment, that is after polymerisation of the said monomer(s) and/or prepolymer(s). However, because the obtained polymer is water repellent, this hinders application of aqueous solutions or dispersions of anatase titanium dioxide nanoparticles. The applicant has found that this drawback can be overcome by applying a suitable primer capable of acting as a binder between the said at least one polymer and the anatase titanium dioxide nanoparticles applied in the form of a powder or an aqueous dispersion onto the said at least one polymer covering at least one surface of the said outdoor fabric.

Advantageously the said primer is a substance which is:
inert in the presence of anatase titanium dioxide,
initially soluble in water but insoluble in water after it has undergone a suitable treatment such as, for example, drying with or without heating.

Preferably the said primer is also resistant to friction.

Preferably the said primer is selected from the group comprising polyvinyl alcohols, melamine monomers and/or prepolymers, vinyl chloride/acrylic acid alkyl esters copolymers, N-methyl acrylamide/acrylic acid alkyl esters copolymers, and acrylic acid/ acrylic acid alkyl esters copolymers, where the acrylic acid alkyl ester unit has the following formula: 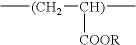
where R is alkyl having 1-4 carbon atoms.

Typically the acrylic acid/acrylic acid alkyl ester copolymer is an acrylic acid/acrylic acid methyl ester copolymer.

Advantageously an acrylic acid/acrylic acid alkyl ester/N-methyl acrylamide terpolymer may be used.

In a preferred embodiment the anatase TiO₂ nanoparticles are dispersed in the primer.

Preferably the said primer is dried at a temperature of from 100° to 180°. Even more preferably it is dried at a temperature from 140° C. to 170°C. Advantageously the said drying is carried out for a sufficient time to eliminate substantially all the water, including the water of reaction which forms during any possible cross-linking of the said primer.

This invention will now be illustrated with reference to the appended figures and the following examples which illustrate the invention without, however, limiting it in any way.

In the figures:

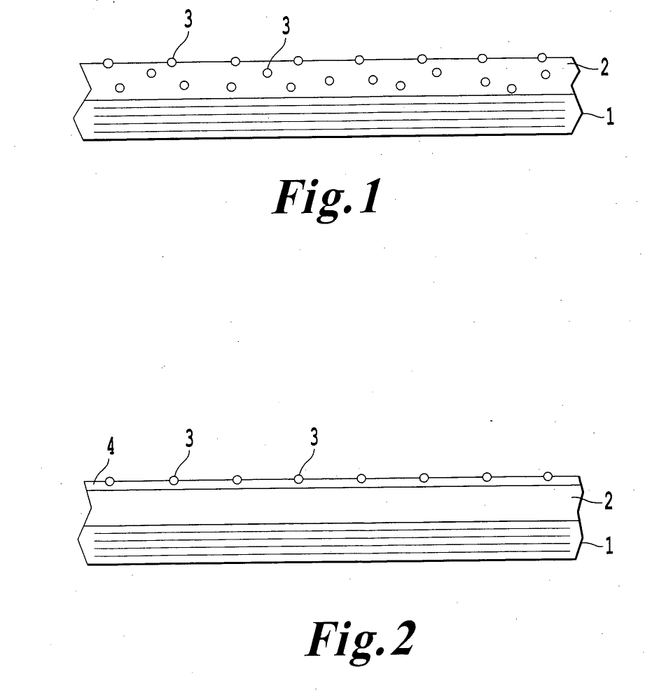

FIG. 1 shows a first embodiment of a fabric according to this invention,

FIG. 2 shows a second embodiment of a fabric according to this invention,

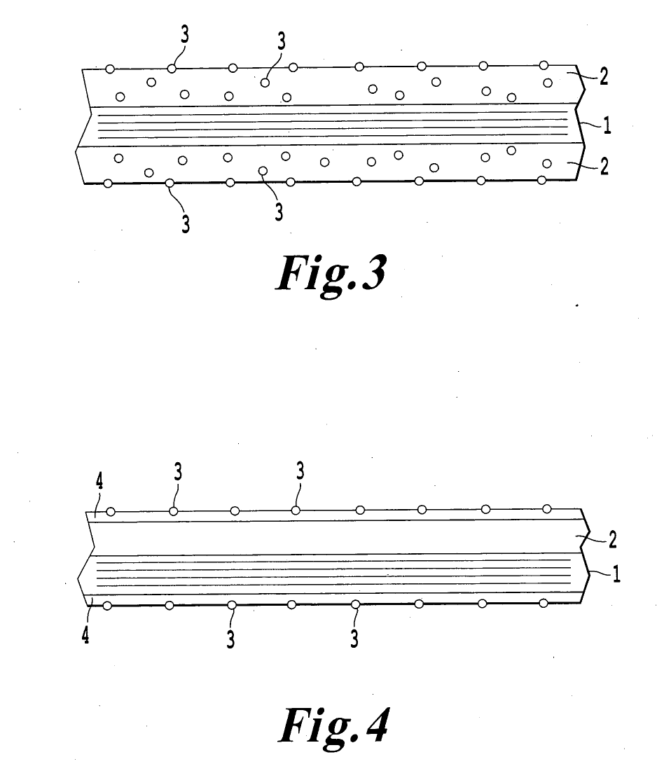

FIG. 3 shows a third embodiment of a fabric according to this invention,

FIG. 4 shows a fourth embodiment of a fabric according to this invention.

In FIGS. 1 and 2 a fabric (1) is covered with a layer of polymer (2 ) on one side only, whereas in FIGS. 3 and 4 a layer of polymer (2) covers both surfaces of fabric (1).

In FIGS. 1 and 3 polymer layer (2) incorporates anatase titanium dioxide nanoparticles (3).

In FIGS. 2 and 4 polymer layer (2) is covered by a layer of primer (4) and the latter incorporates anatase titanium dioxide nanoparticles (3).

### EXAMPLE 1

A white acrylic fibre fabric of 300±15 g/m² was carefully washed in a multistep continuous processing machine with water at 50° C. in order to remove the finish applied to the acrylic fibre by the manufacturer thereof.

At the end of the washing step as much of the wash water as possible was removed from the fabric by pressing between rollers.

The fabric was then dipped for 2-3 seconds in an aqueous bath comprising 3 parts by weight for 100 parts by weight of bath of a fluoropolymer dispersion marketed by Ciba Specialty Chemicals S.p.A. under the trade name Oleophobol™ SL-A01 and 5 parts by weight for 100 parts by weight of bath of a concentrated solution of a alkyl-modified formaldehyde melamine marketed by Ciba Specialty Chemicals S.p.A. under the trade name Lyofix™ MMA to which a powder of anatase titanium dioxide particles having an average size of 100 nm was added in a quantity such as to provide a quantity of anatase TiO₂ on the final fabric of approximately 2.5 parts by weight for 100 parts by weight of fabric.

On leaving the bath the fabric was pressed between rollers to reduce the quantity of water which had to be evaporated and was then placed in a hot air dryer at a temperature of 150° C. for one minute to start the polymerisation step of the melamine resin. At the end of the melamine resin polymerisation step the resulting polymer incorporated the fluoropolymer and anatase TiO₂ nanoparticles.

Finally the fabric was cooled to approximately 30° C. with air and wound onto a roll. The anatase TiO₂ nanoparticles were uniformly distributed over the surfaces and the interstices of the fabric. The homogeneity of the bath may be improved by adding suitable emulsifiers and/or surfactants which are well known to those skilled in the art.

### EXAMPLE 2

The procedure of Example 1 was repeated except that the anatase titanium dioxide powder was not added to the treatment bath and in that before the fabric was placed in the hot air drier both its surfaces were sprayed with a dispersion of anatase TiO₂ particles having an average size of approximately 100 nm in such a way as to apply approximately 0.70 parts by weight of anatase TiO₂ by weight for 100 parts by weight of fabric, corresponding to approximately 2.1 g of anatase TiO₂ for square metre of fabric.

### EXAMPLE 3

3 awnings of a white colour mounted on conventional frames were prepared using samples of fabric from Examples 1 and 2 and a comparison fabric sample A prepared using the same process as in Examples 1 and 2 but without the addition of anatase TiO₂ nanoparticles.

The 3 awnings were exposed to the exterior on the south wall of a building on the plain of northern Italy close to an area of high traffic for 12 months. A reference sample B identical to reference sample A was kept in the dark and away from dust throughout the period of the test.

The 3 exposed awnings were automatically wound up and unrolled every 3 hours during the hours of daylight.

In addition to this the 3 awnings were soaked with an abundant quantity of water and rolled up wet once per week.

After 12 months the fabrics of the awnings were removed from the frames and evaluated.

The amount of dirt was graded according to a visual scale where score 0 corresponds to unexposed reference fabric sample B kept in the dark and away from dust for all 12 months of the test period and score 5 corresponds to reference fabric sample A which was exposed in the manner described above.

The presence of moulds was evaluated and their quantity was estimated with an optical microscope.

The results are shown in Table 1:

TABLE 1

| Sample | Dirtiness evaluation | Moulds |
|---|---|---|
| Example 1 (invention) | 3 | Absent |
| Example 2 (invention) | 1 | Absent |
| A (Comparison) | 5 | >10 spores/m² |
| B (Reference) | 0 | Absent |

The data shown in Table 1 prove the ability of the outdoor fabric according to the invention to maintain an improved aesthetic appearance over time even in the presence of atmospheric agents and pollutants.

In particular the sample from Example 2 has maintained an appearance very similar to that of reference sample B which was kept in the dark away from dust.

1. An outdoor fabric based on spun acrylic fibres wherein the fabric is associated with:
at least one polymer selected from the group comprising melamine resins, fluoropolymers and mixtures thereof, and
nanoparticles of anatase titanium dioxide.

2. A fabric according to claim 1, wherein the nanoparticles have an average size equal or lower than 200 nm.

3. A fabric according to claim 1, wherein the nanoparticles have an average size equal or lower than 50 nm.

4. A fabric according to claim 1, wherein the nanoparticles have an average size equal or lower than 10 nm.

5. A fabric according to claim 1, wherein the at least one polymer and the anatase titanium dioxide nanoparticles are associated with at least one of the two surfaces of the fabric.

6. A fabric according to claim 1, wherein the at least one polymer is a flexible solid matrix of melamine resin incorporating at least one fluoropolymer.

7. A fabric according to claim 6, wherein the flexible solid matrix of melamine resin also incorporates anatase titanium dioxide nanoparticles.

8. A fabric according to claim 1, wherein the fabric is also associated with a primer which:
covers the at least one polymer selected from the group comprising melamine resin, fluoropolymers and mixtures thereof, and
incorporates the anatase titanium dioxide particles.

9. A fabric according to claim 8, wherein the primer which incorporates the anatase titanium dioxide nanoparticles covers the flexible solid matrix of melamine resin which in turn incorporates at least one fluoropolymer.

10. A fabric according to claim 8 or 9, wherein the primer is selected from the group comprising polyvinyl alcohols, melamine monomers and/or prepolymers, vinyl chloride/acrylic acid alkyl ester copolymers, N-methyl acrylamide/acrylic acid alkyl ester copolymers and acrylic acid/acrylic acid alkyl ester copolymers, where the acrylic acid alkyl ester unit has the following formula: 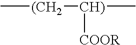
where R is alkyl having 1-4 carbon atoms.

11. A fabric according to claim 1, wherein the quantity of anatase titanium dioxide nanoparticles associated with the fabric is of from 0.1 to 10 parts by weight for 100 parts by weight of fabric.

12. A fabric according to claim 11, wherein the quantity is of from 0.3 to 6 parts by weight for 100 parts by weight of fabric.

13. A fabric according to claim 11, wherein the quantity is of from 0.5 to 5 parts by weight for 100 parts by weight of fabric.

14. A process to improve the resistance of an outdoor fabric to atmospheric agents and pollutants, comprising the steps of associating an outdoor fabric based on spun acrylic fibres with at least one polymer selected from the group comprising melamine resins, fluoropolymers and mixtures thereof, and with anatase titanium dioxide nanoparticles

15. A process according to claim 14, wherein the association of the at least one polymer with the fabric is carried out by applying a liquid mixture comprising at least one preselected monomer and/or prepolymer to the fabric and subsequent heat treatment.

16. A process according to claim 15, wherein the liquid mixture also comprises at least one polymer having a preselected degree of polymerisation so that the subsequent heat treatment promotes polymerisation of the monomer or prepolymer to provide a flexible solid matrix which incorporates the at least one polymer having a preselected degree of polymerisation.

17. A process according to claim 15, wherein the liquid mixture also comprises a catalyst capable of promoting polymerisation of the preselected monomer or prepolymer.

18. A process according to claim 15, wherein the liquid mixture also comprises an emulsifier.

19. A process according to any one of claims from 15 to 18, wherein the liquid mixture also comprises a dispersant.

20. A process according to claim 15, wherein the prepolymer present in the liquid mixture is a melamine-formaldehyde prepolymer.

21. A process according to claim 20, wherein the liquid mixture also comprises a fluoropolymer having a preselected degree of polymerisation so that the subsequent heat treatment promotes cross-linking of the melamine-formaldehyde prepolymer to produce a flexible solid matrix of melamine resin which incorporates the fluoropolymer.

22. A process according to claim 15, wherein the liquid mixture is applied to the fabric by means of a technique selected from the group comprising rolling, brushing, spraying and spreading techniques.

23. A process according to claim 14, wherein the anatase titanium dioxide nanoparticles are associated with the fabric in the form of a powder dispersed in water, a colloidal aqueous dispersion or an aqueous dispersion stabilised with acids.

24. A process according to claim 15, wherein the anatase titanium dioxide nanoparticles are applied to the fabric during or after application of the liquid mixture comprising at least one preselected monomer and/or prepolymer.

25. A process according to claim 24, wherein the anatase titanium dioxide nanoparticles are applied to the fabric before or after heat treatment of the liquid mixture comprising at least one preselected monomer and/or prepolymer.

26. A process according to claim 14, wherein the nanoparticles have an average size equal or lower than 200 nm.

27. A process according to claim 14, wherein the nanoparticles have an average size equal or lower than 50 nm.

28. A process according to claim 14, wherein the nanoparticles have an average size equal or lower than 10 nm.

29. A process according to claim 14, wherein the quantity of anatase titanium dioxide nanoparticles applied to the fabric is of from 0.1 to 10 parts by weight for 100 parts by weight of fabric.

30. A process according to claim 14, wherein the quantity of anatase titanium dioxide nanoparticles applied to the fabric is of from 0.3 to 6 parts by weight for 100 parts by weight of fabric.

31. A process according to claim 14, wherein the quantity of anatase titanium dioxide nanoparticles applied to the fabric is of from 0.5 to 5 parts by weight for 100 parts by weight of fabric.

32. A process according to claim 14, wherein the heat treatment is carried out at a temperature of at least 150° C. for at least 1 second.

33. A process according to claim 14, wherein the heat treatment is carried out at a temperature of from 150° C. to 200° C. for a time of from 1 second to 10 minutes.

34. A process according to claim 14, wherein the heat treatment is carried out at a temperature of from 150° C. to 180° C. for a time of from 1 second to 3 minutes.

35. A process according to claim 25, wherein when the anatase titanium dioxide nanoparticles are applied after the heat treatment which promotes polymerisation of the at least one preselected monomer and/or prepolymer the process further comprises the application of a primer comprising anatase titanium dioxide nanoparticles to the polymer so formed.

36. A process according to claim 35, wherein the primer is selected from the group comprising polyvinyl alcohol, melamine monomers and/or prepolymers, vinyl chloride/acrylic acid alkyl ester copolymers, N-methyl acrylamide/acrylic acid alkyl ester copolymers, and acrylic acid/acrylic acid alkyl ester copolymers, where the acrylic acid alkyl ester unit has the following formula: 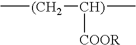
where R is alkyl having 1-4 carbon atoms.

37. A process according to claim 36, wherein the primer is an aliphatic acid/acrylic acid methyl ester copolymer.

38. A process according to claim 36, wherein the primer is an acrylic acid/acrylic acid alkyl ester/N-methyl acrylamide terpolymer.

39. A process according to claim 35, wherein the primer is dried at a temperature of from 100° C. to 180° C.

40. A process according to claim 35, wherein the primer is dried at a temperature of from 140° C. to 170° C.
